(19) United States
(12) Patent Application Publication
(10) Pub. No.: US 2016/0203304 A1
(43) Pub. Date: Jul. 14, 2016

(54) ADAPTIVE ELECTRONIC DEVICE INTERFACE

(71) Applicant: PHYSIO-CONTROL, INC., Redmond, WA (US)

(72) Inventors: Matthew Lawrence BIELSTEIN, Seattle, WA (US); Jeffery Scott EDWARDS, Bellingham, WA (US)

(21) Appl. No.: 14/914,635

(22) PCT Filed: Aug. 29, 2014
(86) PCT No.: PCT/US14/53604

§ 371 Date: Feb. 25, 2016

Related U.S. Application Data
(60) Provisional application No. 61/871,804, filed on Aug. 29, 2013.

(51) Int. Cl. G06F 21/31; H04W 12/08; G06F 3/0484

(52) U.S. Cl. CPC G06F 21/31; G06F 3/04842; H04W 12/08

(57) ABSTRACT

Technologies and implementations for configuring of an adaptable user interface are generally disclosed. The configuring may be based, at least in part, on a credential of a user and/or environment information of the adaptable user interface.

### RELATED APPLICATION

This application claims benefit of priority to U.S. Provisional Patent Application Ser. No. 61/871,804, filed on Aug. 29, 2013, titled User-Tailored Auto Configuration of a Medical Device Settings, which is incorporated herein by reference in its entirety.

### BACKGROUND

Unless otherwise indicated herein, the approaches described in this section are not prior art to the claims in this application and are not admitted to be prior art by inclusion in this section.

As sophisticated electronic devices become more common to include the capabilities of providing a wide range of functionalities, user interaction with these sophisticated electronic devices may be complicated as well. Often times, a wide range of users may use these electronic devices. These users may have varying capabilities and needs. Additionally, these users may use these electronic devices in various locations and/or environments. Accordingly, usability of these electronic devices by various users in various locations and/or environments may be difficult.

### SUMMARY

The present disclosure describes example methods, apparatus, and systems related to configuring an adaptive user interface. An example method may include a method for configuring an adaptive user interface associated with an electronic device, where the method may include receiving credential information from a user at the electronic device via a first electronic communication medium, receiving location information of the electronic device via a second electronic communication medium, determining environment information of the electronic device based, at least in part, on the received location information of the electronic device, and configuring the adaptive user interface based, at least in part, on the credential information and/or the determined environment information.

The present disclosure also describes various example machine readable media having stored therein instructions that, when executed by one or more processors, operatively enable a user interface module to receive credential information from a user at an electronic device via a first electronic communication medium, receive location information of the electronic device via a second electronic communication medium, determine environment information of the electronic device based, at least in part, on the received location information of the electronic device, and configure the adaptive user interface based, at least in part, on the credential information and/or the determined environment information.

The present disclosure additionally describes example systems for configuring an adaptive user interface associated with an electronic device. Example systems may include a processor, a location module communicatively coupled to the processor, a communication module communicatively coupled to the processor, an adaptive user interface communicatively coupled to the processor, and a user interface module communicatively coupled to the processor. The user interface module may be configured to receive credential information from a user at an electronic device via a first electronic communication medium, receive location information of the electronic device via a second electronic communication medium, determine environment information of the electronic device based, at least in part, on the received location information of the electronic device, and configure the adaptive user interface based, at least in part, on the credential information and/or the determined environment information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates an example system for configuration of an adaptive user interface in accordance with one or more embodiments;

FIGS. 2a and 2b illustrate block diagrams of a configured adaptive user interface, in accordance with various embodiments;

FIGS. 3a and 3b illustrate block diagrams of a configured adaptive user interface, in accordance with various embodiments;

FIG. 4 illustrate an operational flow for configuring an adaptable user interface, arranged in accordance with at least some embodiments described herein;

FIG. 5 illustrates an example computer program product, arranged in accordance with at least some embodiments described herein; and

FIG. 6 is a block diagram illustrating an example computing device, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to an adaptable user interface, which may be included in an electronic device. Such a user interface may include display devices, physical input devices, image detection devices, motion detection device, etc.

With advances in processing power, electrical devices have become more sophisticated providing a wide range of functionalities. Accordingly, user interaction with these sophisticated electrical devices may be complicated as well. In order to describe the present disclosure, references may be made to certain types of electronic devices such as, but not limited to medical type devices. However, it should be appreciated by those skilled in the relevant art that the claimed subject matter may be applicable to wide range of electronic devices such as, but not limited to, computers, vehicles, residential control settings, handheld devices, appliances, wearable electronic devices, a wide range of consumer electronics, and so forth. Accordingly, the claimed subject matter is not limited in these respects.

In a non-limiting example, assume that an electronic device be a medical device type kind, where the medical device may be located in a hospital. The medical device may have a wide range of functionalities such as, but not limited to, reading various symptoms of a patient, administering various treatments for the patient, communicating with various other devices, etc. In this example, assume that a medical doctor is using the medical device on the patient. In order to use the medical device, the doctor may have logged into the medical device, brought the medical device with them, or simply turned on the medical device using some form of identification (i.e., credentials of the user may be received by the medical device). Once the credentials of the user are received, the medical device may ready itself for use. In one example, the medical device may ready itself for use by configuring a user interface tailored for the credentials corresponding to the user (e.g., the medical doctor).

The medical device may receive information, which may be used for configuration of the user interface, via a variety of methods. For example, the medical device may receive information via a wireless electronic communication medium. Some examples of a wireless communication medium may include, near field communication (NFC) type electronic communication medium, a radio-frequency identification (RFID) type of wireless electronic communication medium, a Bluetooth wireless electronic communication medium, a wireless local area network (WLAN) type wireless electronic communication medium, and so forth. Taking for example the wireless communication medium of NFC type, the medical doctor may have a portable electronic device such as, but not limited to, a smart phone, and included in the smart phone, there may be an application for providing configuration information for a user interface of a medical device based, at least in part, on an owner of the smart phone (e.g. the credentials of the user). Continuing with this example, once the medical doctor turns on the medical device, the medical device may receive the medical doctor's credentials along with the information to be used to configure the medical device's user interface for the medical doctor, via the NFC type electronic communication medium from the medical doctor's smart phone.

Once the user interface is configured, the user interface may help facilitate the medical doctor to read an output of the various symptoms and make a diagnosis. Additionally, since the person using the medical device is a medical doctor, the medical device may facilitate administering of a treatment (e.g., drug delivery, electric shock, etc.). That is, a user interface may be configured such that the medical doctor may be able to administer a drug to treat the diagnosed issue with the patient. For example, the display and/or keys on the medical device may facilitate control of an intravenous flow controller, control of a robotic syringe, control of opening a compartment having a drug corresponding to the treatment of the diagnosed symptom, etc. Further, the medical device may be capable of communicating its usage to other devices such as, but not limited to, a server type computing device at the hospital for various record keeping and/or analyzing purposes.

In another example, assume that a nurse is using the medical device, and in order to use the medical device, the medical device may have received the credential information of the nurse, as previously described. Here again, once the credentials of the user (i.e., the nurse) are received, the medical device may ready itself for use by configuring a user interface tailored for the credentials corresponding to the nurse.

As previously mentioned, the medical device may receive information, which may be used for configuration of the user interface, via a variety of methods. Taking the example of an electronic communication medium of a WLAN type wireless electronic communication medium, the medical device may have received the credential information of the nurse (e.g., login on the medical device, a scan of the nurse's identification badge, RFID type electronic communication with the nurse's identification card, NFC type electronic communication with a handheld device from the nurse, etc.). Once the credential information of the nurse is received, the medical device may configure the user interface by receiving configuration information via the WLAN type electronic communication medium from a resource such as, but not limited to, a server, the cloud, another medical device, etc., and/or any combination thereof.

Continuing with the example of the nurse, once the user interface is configured, the user interface may help facilitate the nurse to use the medical device tailored for the nurse. For example, the user interface on the medical device may facilitate administering a treatment already prescribed by a medical doctor. However, other functionalities such as, but not limited to, reading various symptoms of a patient, communicating with various other medical devices, etc., may not be available to the nurse, and accordingly, the user interface on the medical device may be configured as such.

It should be appreciated that these functionalities are generalizations of medical device functionalities corresponding to a medical doctor or a nurse, and accordingly, the functionalities are provided as general examples. For example, the functionalities of the medical device may be based, at least in part, on the training received by a user (i.e., in the nurse example, the nurse may be able to make a diagnosis).

The examples of the medical doctor and the nurse adaptive user interface may provide a clear intent of the present disclosure. However, further examples may be described to provide some further details of the present disclosure. Additionally, as previously stated, the present disclosure may be described in the context of medical devices. However, as one may appreciate, it is contemplated that the implementations and/or methodologies disclosed herein may be applicable to a wide range of electronic devices such as, but not limited to, computers, vehicles, residential control settings, handheld devices, appliances, televisions, wearable electronic devices, a wide range of consumer electronics, and so forth.

For example, continuing with the medical related field, medical devices may be capable of providing a variety of functionalities. A non-limiting example of a sophisticated medical device may be an advanced life support (ALS) system device such as, but not limited to, a defibrillator type medical device (hereon out “DEFIB device”) having a user interface. It should be appreciated that the user interface may include a wide variety of user interfaces such as, but not limited to, displays, graphical user interface, physical peripheral device type user interface, visual type user interface, audio based type user interface, etc. In this example, a user interface included in the DEFIB device may be configured to be capable of providing the appropriate level of functionality based, at least in part, on the user and/or the environment where the DEFIB device is to be used. In this example, the DEFIB device may include an automatic functionality mode and a manual functionality mode.

In the automatic functionality mode, the user interface may be configured to facilitate use by a non-medically trained user such as, but not limited to, a layperson. Because the layperson may not be familiar with the various capable functionalities of the DEFIB device such as, but not limited to, the electrical activity of a person's heart over time such as, but not limited to, an electrocardiogram (i.e., ECG or EKG), the user interface of the DEFIB device may be configured in such a manner as to not include the electrocardiogram functionality. Accordingly, in the automatic functionality mode, the user interface may be limited to facilitate ease of use by the layperson (e.g., a limited number of active buttons and/or limited graphical user interface options). However, in the manual functionality mode, the user interface may be configured differently.

In the manual functionality mode, the user interface may be configured to facilitate use by a medically trained user such as, but not limited to, a medical doctor. Because the medical doctor may be familiar and trained with the various capable functionalities of the DEFIB device such as, but not limited to, electrocardiogram, the user interface of the DEFIB device may be configured in such a manner as to include the electrocardiogram functionality. Accordingly, in the manual functionality mode, the user interface may be functionality rich to facilitate full diagnostic and treatment functionalities for the medical doctor (e.g., wide number of active buttons and/or wide number of graphical user interface options including the automatic functionality mode).

Additionally, in the above examples of the DEFIB device capable of having at least two user interfaces, the information to configure the user interfaces may be received from outside the DEFIB device itself. That is, the DEFIB device may not already have the information to configure the user interfaces preinstalled, but instead, the information to configure the user interfaces may be received once the DEFIB device has been activated and the user type (i.e., user credential) information has been received by the DEFIB device. As will be described later, the information to configure the user interfaces may be received via a variety of electronic communication mediums such as, but not limited to, wireless electronic communication medium, wired electronic communication medium, and so forth. In the non-limiting example of the DEFIB device, the DEFIB device may have both the automatic functionality mode and the manual functionality mode and be capable of configuring the user interface to adapt to the type of user (i.e., credentials of the user).

Continuing with the non-limiting example of the DEFIB device, in another example, the functionalities of the DEFIB device may be based, at least in part, on its location. For example, the DEFIB device may be located in a medical facility type setting, where the medical facility may have more than one area directed towards various areas of medical care. For example, one area of the medical facility may be directed towards pediatric medical care, another area may be directed towards emergency medical care, another area may be directed towards cardiac medical care, etc. In an example scenario, a medical doctor may need to use a DEFIB device on a child patient in the area directed towards pediatric medical care. Because the credentials of the user in this case is a medical doctor, the DEFIB device may have the user interface configured to be used by the medical doctor (e.g., manual functionality mode with correspondingly wide variety of available functionalities). However, the DEFIB device may be able to determine the environment of its location (e.g., area directed towards pediatric medical care), and based upon this determination, the DEFIB device may configure the user interface to facilitate use of the DEFIB device with a child patient (e.g., different range of electrical power for shock, different weight ranges, a theme on a display on the DEFIB device may be configured towards children, sounds may be tailored towards children, etc.). Accordingly, the user interface of the DEFIB device may be configured based on the type of user (e.g., medical doctor) and/or the environment of the DEFIB device (e.g., area directed towards pediatric medical care).

In another example, a DEFIB device may be located in a train station, where the train station may be a noisy environment with a higher likelihood that a person who may use the DEFIB device may be a layperson with limited to no medical training. Starting with an example of a DEFIB device having limited to no pre-installed user configuration information, one example scenario may be that a user may need to use the DEFIB device on a person (e.g., a layperson) at the train station. The user may activate the DEFIB device, and the DEFIB device may receive credentials of the user via some electronic communication medium such as, but not limited to, a mobile phone, a button that may indicate whether a person is medically trained or not, a medical identification card having some form of radio-frequency identification (RFID) technology, etc. In this example, once the DEFIB device receives the credential information of the user, the medical device may receive location information of the DEFIB device (i.e., the train station) as well

As will be described in detail, the location information may be received via an electronic communication medium such as, but not limited to, a global positioning system (GPS) related electronic communication medium. Additionally, based, at least in part, on the location information, the DEFIB device may determine environment information of the DEFIB device (e.g., the train station, where it may be commonly a noisy environment). Based, at least in part, on the determined environment information, the DEFIB device may configure the user interface accordingly. That is, the user interface may include audio instructions having high volume to at least compensate for the noisy environment. Alternatively or in combination with, the DEFIB device may configure the user interface based, at least in part, on the layperson using the DEFIB device. For example, the DEFIB device may configure the user interface to be in an automatic functionality mode, where there may be a single button or screen to activate the DEFIB device and allow the DEFIB device to provide audio instructions to the user including administering appropriate electric shock. Accordingly, the DEFIB device may configure the user interface based, at least in part, on the credential information (e.g., the layperson), the determined environment information, and/or any combination thereof.

In another non-limiting example, a medical device may be a medical imaging type device. For example, the medical imaging type device may be a diagnostic ultrasound device. The ultrasound device may include various interface methods such as, but not limited, to a touch screen display, a keyboard, and a trackball type device. For this example, at least three different users may be described, a medical doctor, an ultrasound technician, a patient.

Starting with the ultrasound technician, the ultrasound technician may turn on the ultrasound device. Once the ultrasound device is turned on, the ultrasound device may receive credential information from the ultrasound technician via an electronic communication medium such as, but not limited to, an RIFD tag included in the ultrasound technician's identification card, badge, etc. The credential information may indicate that the user is an ultrasound technician. Additionally, the ultrasound device may receive location information via another electronic communication medium such as, but not limited to, a GPS type electronic communication medium. Based, at least in part, on the determined location information of the ultrasound device, the environment information of the ultrasound device may be determined such as, but not limited to, an obstetrics and gynecological (OB/GYN) environment due to the location of the ultrasound device (e.g., location of the OB/GYN area). Accordingly, based, at least in part, on the credential information (i.e., the ultrasound technician) and/or the determined environment information, the ultrasound device may configure the user interface accordingly. For example, various keys on the keyboard may not be active for the ultrasound technician as compared to the medical doctor, various menus may not be available for the ultrasound technician as compared to the medical doctor, and/or there may be areas the trackball would not allow for various interaction for the ultrasound technician as compared to the medical doctor. It should be appreciated that the opposite may also be true such as, but not limited to, various keys on the keyboard may be active for the ultrasound technician, while not active for the medical doctor.

It should be appreciated that the above example may also extend to the credentials of the patient. That is, the ultrasound device may configure the user interface differently for the patient. For example, the display on the ultrasound device may display very limited information as compared to the information available and displayed for the medical doctor or the ultrasound technician.

In yet another non-limiting example, a medical device may include image capturing/detecting capabilities such as, but not limited to, a camera type device. The camera type device may help facilitate receiving credential information from a user at the medical device. For example, the camera type device may be communicatively coupled to a facial recognition module or modules that may facilitate facial recognition. Continuing with this non-limiting example, once a user turns on the medical device or the medical device is already in the active state, the camera may detect a user's face. Upon detection of the user's face, a facial recognition module may recognize the face and may determine the credential information of the user. However, if the facial recognition module cannot recognize the face of the user, the credential of the user ma be designated as a layperson by default, and accordingly, notwithstanding the environment information, the medical device may configure the user interface for use by a layperson.

In another non-limiting example, a medical device may include a learning module. In this example, the medical device may have already configured an adaptive user interface for a user based, at least in part, on credential information and/or a determined environment information. The learning module may be communicatively coupled to the adaptive interface. The learning module may receive information regarding the interaction/interactions of the user, and determine which sequence of interactions is most utilized by the user. The learning module may correlate the received information regarding the interaction/interactions of the user with the credentials of the user. That is, the learning module may help facilitate configuring the adaptive user interface in a manner to provide improved efficiency for the user based, at least in part, on the credentials of the user. For example, when using a particular medical device, a medical doctor may continually interact (e.g., click on, press keys, etc.) on a sequence of most used interactions. Based, at least in part, on the most used interactions, the next time the medical device receives credential information similar to the medical doctor, the medical device may configure the adaptive user interface in a manner to provide improved efficiency for the user based, at least in part, on information received from the learning module (e.g., arrangement of a selectable graphical icons, various aggregation of interactive keys, and so forth).

In yet another non-limiting example, a medical device may have the capabilities of preventing confusion of the credentials of more than one user. For example, once a medical device configures an adaptive interface, the medical device may determine if a subsequent credential information is received. For example, in the case of a medical device capable of receiving credentials of a user via a wireless electronic communication medium, another user may be proximate to the medical device close enough for the medical device to be able to receive credential information from another user. In order to reduce the likelihood of confusion (e.g., configuring the user interface for the subsequent user, while the first user is using the medical device), the medical device may lock the adaptive user interface. In one example, if a second and/or subsequent credential information of a user is received, the medical device may request some alternative information such as, but not limited to, a secondary login pass code (i.e., an override type information). If the medical device receives the alternative information, the medical device may receive credential information of the subsequent user and configure the adaptive user interface accordingly irrespective of the first user using the adaptive user interface prior to the subsequent user.

In yet another non-limiting example, a medical device may facilitate configuration of an adaptive user interface based, at least in part, on a hierarchical credential information and/or environment information. For example, a medical device may have an adaptive user interface configured for use by a layperson. However, if the medical device receives credential information of a user, who may be considered to be more suitable to use the medical device such as, but not limited to, a medically trained person (e.g., a medical doctor, a nurse, an emergency medical technician, etc.), the medical device may configure the adaptive user interface accordingly irrespective of the first user using the adaptive user interface prior to the subsequent user (i.e., override the layperson).

In another non-limiting example, a medical device may facilitate configuration of an adaptive user interface based, at least in part, on a hierarchical environment information. For example, a medical device may override configuration of an adaptive user interface if an environment information changes to a more applicable environment for the medical device and/or the user. An example may be where a medical doctor may be using a medical device such as, but not limited to, a DEFIB device in a pediatric environment. However, a nurse may move the DEFIB device to an emergency room environment. Even though the medical doctor may be a user, who may be considered to be more suitable user of the DEFIB device than the nurse, the medical device may configure the adaptive interface for the nurse based, at least in part, on the environment information being an emergency room, thereby overriding the medical doctor's interface in the pediatric environment.

As described, a medical device may facilitate configuration of an adaptive user interface based, at least in part, on credentials of a user and/or environment of the medical device.

Before moving on to the description of the figure, even though the above may have been mostly described with respect to medical devices, it should be appreciated that it is contemplated within the present disclosure that the claimed subject matter may be applicable to a wide variety of electronic devices, and accordingly, the claimed subject matter is not limited in scope to the particular implementations described herein.

Additionally, it should be appreciated that a user may include the young and the elderly. Accordingly, it is contemplated within the present disclosure that the claimed subject matter may be applicable to wide variety users such as, but not limited to, children, elderly, male, female, and so forth. For example, configuration of a user interface is not limited to professional credentials of a user, but instead, may extend to a wide variety of users. Accordingly, the claimed subject matter is not limited in scope to the particular implementations described herein.

Further, configuration of a user interface may be provided by physical means such as, but not limited to, communicatively coupling a second electronic device with a first electronic device. For example, an accessory type device may be communicatively coupled to an electronic device, and based, at least in part, on the accessory, a user interface may be configured for use with the accessory. In some examples, the configuration of the user interface may be to facilitate use of the accessory with the electronic device. In another example, the configuration of the user interface may be to facilitate use of the electronic device with the accessory. Continuing with the example of the medical device (i.e., DEFIB device), attaching a type of electrode to the DEFIB device may facilitate configuration a user interface of the DEFIB device to facilitate utilization of the attached electrode. Further, attaching a different type of electrode to the DEFIB device may facilitate configuration a user interface of the DEFIB device to facilitate utilization of the different type of electrode attached to the DEFIB device.

Additionally, as previously stated, the present disclosure may be described in the context of medical devices. However, as one may appreciate, it is contemplated that the implementations and/or methodologies disclosed herein may be applicable to a wide range of electronic devices such as, but not limited to, computers, vehicles, residential control settings, handheld devices, appliances, televisions, wearable electronic devices, a wide range of consumer electronics, and so forth.

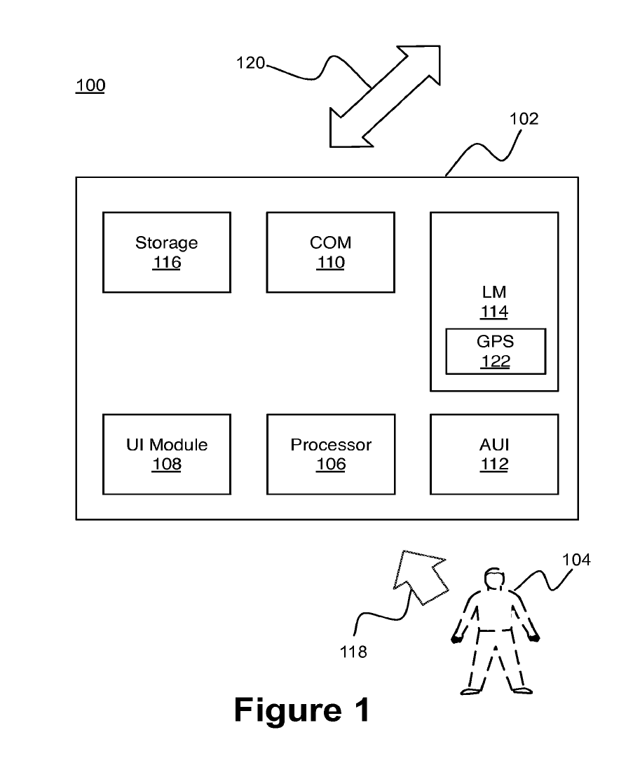

FIG. 1 illustrates an example system for configuration of an adaptive user interface in accordance with one or more embodiments. In FIG. 1, a system 100 may include an electronic device 102 and a user 104. Additionally, the electronic device 102 may include a processor module (processor) an adaptive user interface configuration module (UI module) 108, an electronic communication medium module (COM) 110, an adaptive user interface (AUI) 112, a location management module (LM) 114, and storage medium (storage) 116. The processor 106, UI module 108, the COM 110, the AUI 112, the LM 114, and the storage 116 may be communicatively coupled to each other. In general, the electronic device 102 may receive credential information from the user 104 via a first electronic communication medium 118. The electronic device 102 may receive location information of the electronic device 102 via a second electronic communication medium 120. The LM 114 may determine environment information of the electronic device 102 base, at least in part, on the received location information. The UI module 108 may configure the AUI 112 based, at least in part, on the credential information and/or the determined environment information.

The COM 110 may help facilitate management of the electronic communication of the electronic device 102. For example, the first electronic communication medium 118 may include a wireless electronic communication medium such as, but not limited to, a NFC type electronic communication medium, a RFID type of wireless electronic communication medium, a Bluetooth wireless electronic communication medium, a wireless local area network (WLAN) type wireless electronic communication medium, and so forth. Accordingly, the claimed subject matter is not limited in scope in these respects. Additionally, examples of the second electronic communication medium 120 may include substantially similar example electronic communication medium as the first electronic communication medium 118. In some examples, the first communication medium 118 may be substantially the same as compared to the second electronic communication medium 120. For example, the first communication medium 118 may be of a NFC type electronic communication medium and the second electronic communication medium 120 may also be of a NFC type electronic communication medium (i.e., credential information and/or location information may be both received from the user 104). In some examples, the first and second electronic communication mediums 118 and 120 may be of the wired type (e.g., wired local area network such as, but not limited to, an Ethernet).

The LM 114 may help facilitate management of location information and facilitate determination of the environment of the electronic device 102. In one example, the LM 114 may include a GPS module 122 to receive location information of the electronic device 102. Additionally, the LM 114 may communicate with the storage medium 116, where the storage medium 116 may include environment information. Based, at least in part, on the received location information, the LM 114 may determine environment information of the electronic device 102. It should be appreciated that in some examples, the location information and/or the environment information may be received via the first electronic communication medium 118 or the second electronic communication medium 120. That is, the electronic device 102 may not include the GPS module 122 and/or the storage 116.

The UI 108 module may facilitate management and configuration of the AUI 112 in accordance with various examples as disclosed herein. In one example, the UI module 108 may receive the credential information from the user 104 via the first electronic communication medium 118. Once the credential information of the user 104 is received, the UI module 108 may communicate with the storage medium 116, where the storage medium 116 may include various adaptive user interface configuration information. In another example, once the credential information of the user 104 is received, the UI module 108 may utilize the first electronic communication medium 118 and/or the second electronic communication medium 120 to receive various adaptive user interface configuration information. Accordingly, in some examples, the UI module 108 may configure the AUI 112 based, at least in part, on the credential information received from the user 104 and/or the determined environment information from the LM 114.

The AUI 112 may include a wide range of user interfaces such as, but not limited to direct manipulation, graphical, web-based, touchscreen, command line, gesture, intelligent, motion, audio, spatial, and so forth. Accordingly, the claimed subject matter is not limited in these respects.

The processor 106 may help facilitate execution, management, and/or coordination of the various components and/or modules of the electronic device 102. The processor 106 may be implemented in a wide variety of manners for causing actions and operations to be performed. Some examples may include digital and/or analog processors such as microprocessors and digital-signal processors (DSPs), controllers such as microcontrollers, software running in a machine environment, programmable circuits such as Field Programmable Gate Arrays (FPGAs), Field-Programmable Analog Arrays (FPAAs), Programmable Logic Devices (PLDs), Application Specific Integrated Circuits (ASICs), and so on or any combination thereof. Accordingly, the claimed subject matter is not limited in these respects.

It should be appreciated that location information may include a wide range of location information such as, but not limited to, geographic, a position in a physical space, address, and so forth. Accordingly, the claimed subject matter is not limited in these respects.

It should be appreciated that environment information may include a wide variety of information such as, but not limited to, geographic location, country, language, time zone, cultural information, ethnic information, temperature, humidity, weather, altitude, and so forth. Accordingly, the claimed subject matter is not limited in scope to the particular implementations described herein.

Additionally, in some example implementations, based, at least in part, on the desired functionality and/or implementations, the electronic device 102 may include some, while not others, of the various components and/or modules. For example, the electronic device 102 may include the storage 116 while not the processor 106, while in other implementations, the electronic device 102 may include the processor 106 while not the storage 116 or the COM 110, or any combination/substitution thereof. Accordingly, in at least this respect, the claimed subject matter is not limited in scope.

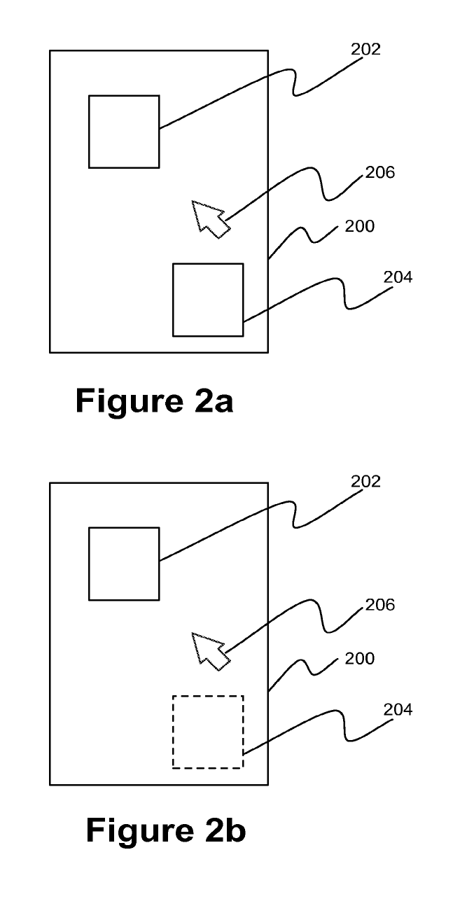

Turning now to FIGS. 2a-2b, some examples of a configured adaptive user interface may be illustrated. In FIG. 2a, an adaptive user interface (AUI) 200 (e.g., AUI 112 shown in FIG. 1) may include a first selectable graphical icon (first SGI) 202 and a second selectable graphical icon (second SGI) 204. Additionally, shown in FIG. 2a is a graphical representation of a pointer 206. The AUI 200 may have been configured based, at least in part, on credential information and/or determined environment information as previously described. Continuing with the example of a medical doctor and a layperson, the AUI 200 may have been configured for the medical doctor allowing the medical doctor to be able to select the first and/or the second SGIs 202 and 204 with the pointer 206.

Referring now to FIG. 2b, the AUI 200 shown in FIG. 2b may have been configured based, based at least in part, on an alternate credential information and/or an alternate environment information. For example, FIG. 2b may have been configured for use with a layperson. Accordingly, as shown, the AUI 200 may have the first SGI 202, but the second SGI 204 may have been “greyed out” (i.e., the second SGI may have a graphical indication that it may not be available to be selected) or may not be displayed at all. Accordingly, the layperson may to be able to select only the first SGI 202 with the pointer 206.

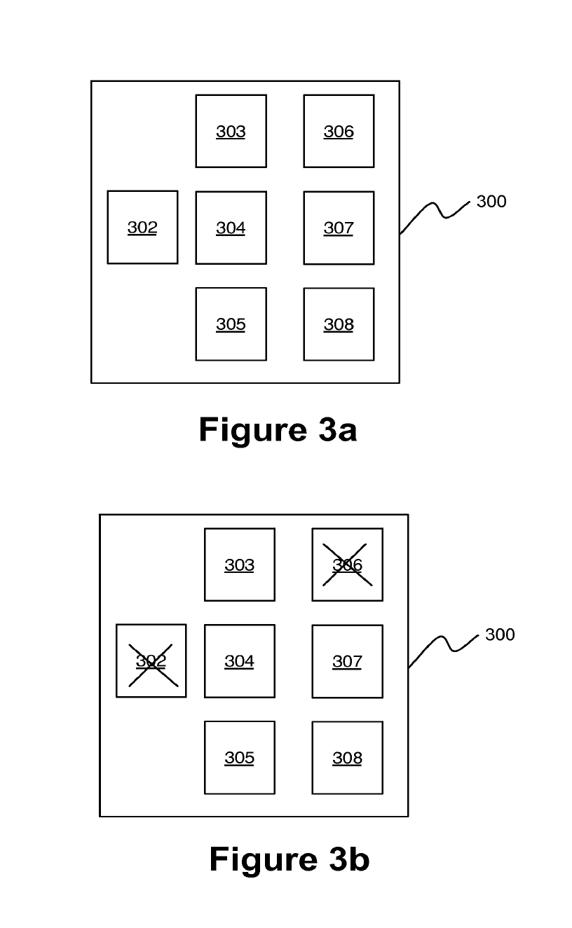

Turning now to FIGS. 3a-3b, some examples of a configured adaptive user interface may be illustrated. In FIG. 3a, an adaptive user interface (AUI) 300 (e.g., AUI 112 shown in FIG. 1) may include a number of physical user input keys (PUIKs) 302-308. The AUI 300 may have been configured based, at least in part, on credential information and/or determined environment information as previously described. Continuing with the example of a medical doctor and a layperson, the AUI 300 may have been configured for the medical doctor allowing the medical doctor to be able to enter a user input using any and all of the PUIKs 302-308 (i.e., electrical signals received by the AUI from any of the PUIKs 302-308 may be processed).

Referring now to FIG. 3b, the AUI 300 shown in FIG. 3b may have been configured based, based at least in part, on an alternate credential information and/or an alternate environment information. For example, FIG. 3b may have been configured for use with a layperson. Accordingly, as shown, even though the AUI 300 may include all of the PUIKs 302-308, PUIK 302 and PUIK 306 may not be available to the layperson (i.e., the electrical signals received from PUIK 302 and/or PUIK 306 may not be processed). Accordingly, the layperson may to be able to enter a user input using a limited number of PUIKs 303-305 and 307-308.

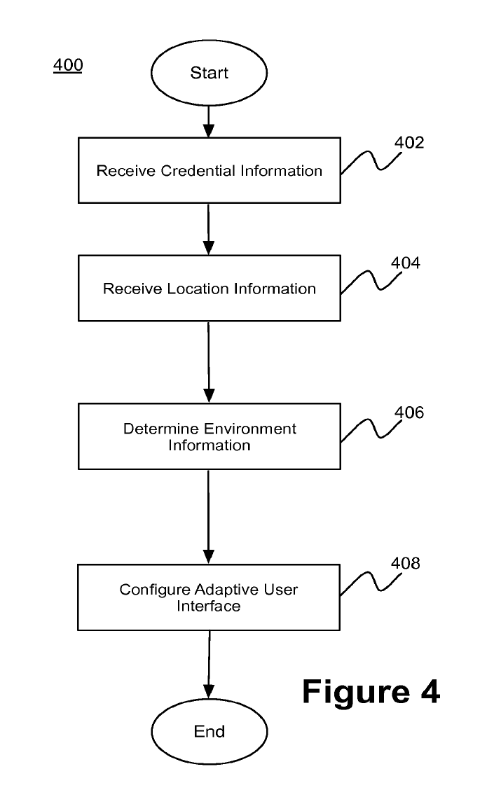

FIG. 4 illustrate an operational flow for configuring an adaptable user interface, arranged in accordance with at least some embodiments described herein. In some portions of the description, illustrative implementations of the method are described with reference to the elements of electronic device and adaptive user interface depicted in FIGS. 1, 2a, 2b, 3a, and 3b. However, the described embodiments are not limited to these depictions. More specifically, some elements depicted in FIGS. 1, 2a, 2b, 3a, and 3b may be omitted from some implementations of the methods details herein. Furthermore, other elements not depicted in FIGS. 1, 2a, 2b, 3a, and 3b may be used to implement example methods detailed herein.

Additionally, FIG. 4 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 400 may be employed as part of a user interface module. Beginning at block 402 (“Receive Credential Information”), an electronic device 102 (shown in FIG. 1) may receive credential information from a user 104 via a first electronic communication medium 118. The first electronic communication medium may include a wide variety of electronic communication medium such as, but not limited to wireless and/or wired electronic communication medium.

Continuing from block 402 to 404 (“Receive Location Information”), the electronic device 102 may receive location information of the electronic device 102 via a second electronic communication medium 120. The location information may be received via a GPS module included in the electronic device. Alternatively, the location information may be received in a wide variety of manner dependent, in part, on the electronic communication medium. Additionally, the second electronic communication medium may include a wide variety of electronic communication medium such as, but not limited to wireless and/or wired electronic communication medium.

Continuing from block 404 to 406 (“Determine Environment Information”), the electronic device 102 may determine environment information of the electronic device based, at least in part, on the received location information of the electronic device. The determined environment information may include a wide range of environment information such as, but not limited to, type of surroundings (e.g., pediatric, train station), language, cultural, ethnic, temperature, humidity, time zone, etc. Accordingly, the claimed subject matter is not limited in these respects.

Continuing from block 406 to 408 (“Configure Adaptive User Interface”), the electronic device 102 may configure the adaptive user interface based, at least in part, on the credential information and/or the determined environment information as shown in FIGS. 2a, 2b, 3a, and 3b.

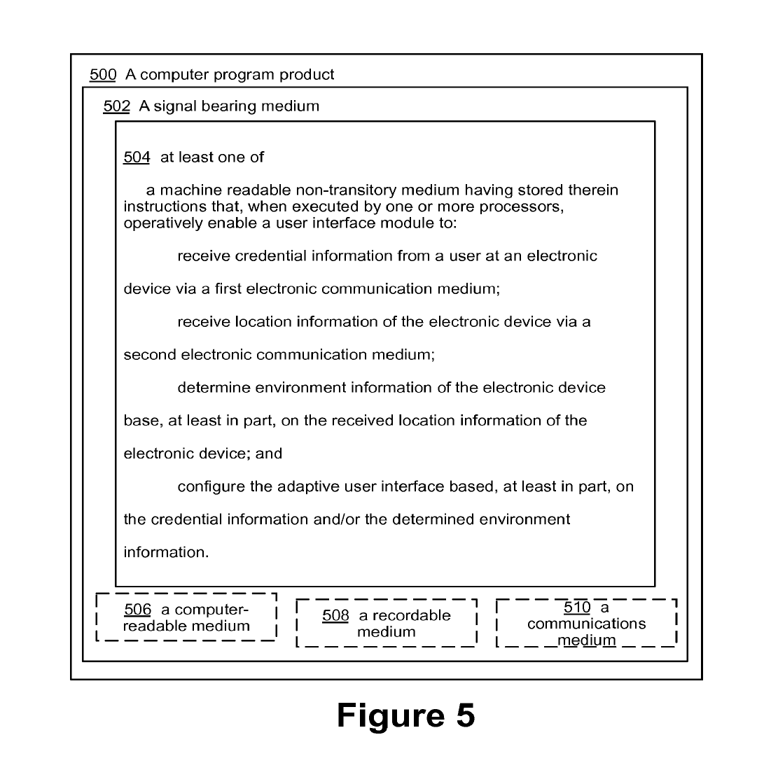

In general, the operational flow described with respect to FIG. 4 and elsewhere herein may be implemented as a computer program product, executable on any suitable computing system, or the like. For example, a computer program product for facilitating configuration of an adaptive user interface may be provided. Example computer program products may be described with respect to FIG. 5 and elsewhere herein.

FIG. 5 illustrates an example computer program product 500, arranged in accordance with at least some embodiments described herein. Computer program product 500 may include machine readable non-transitory medium having stored therein instructions that, when executed, cause the machine to configure an adaptive user interface, according to the processes and methods discussed herein. Computer program product 500 may include a signal bearing medium 502. Signal bearing medium 502 may include one or more machine-readable instructions 504 which, when executed by one or more processors, may operatively enable a computing device to provide the functionality described herein. In various examples, the devices discussed herein may use some or all of the machine-readable instructions.

In some examples, the machine readable instructions 504 may include detecting an electrical signal. In some examples, the machine readable instructions 504 may include receiving location information of the electronic device, via a second electronic communication medium. In some examples, the machine readable instructions 504 may include receiving location information of the electronic device, via a second electronic communication medium. In some examples, the machine readable instructions 504 may include determining environment information of the electronic device based, at least in part, on the received location information of the electronic device. In some examples, the machine readable instructions 504 may include configuring the adaptive user interface based, at least in part, on the credential information and/or the determined environment information.

In some implementations, signal bearing medium 502 may encompass a computer-readable medium 506, such as, but not limited to, a hard disk drive, a Compact Disc (CD), a Digital Versatile Disk (DVD), a Universal Serial Bus (USB) drive, a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

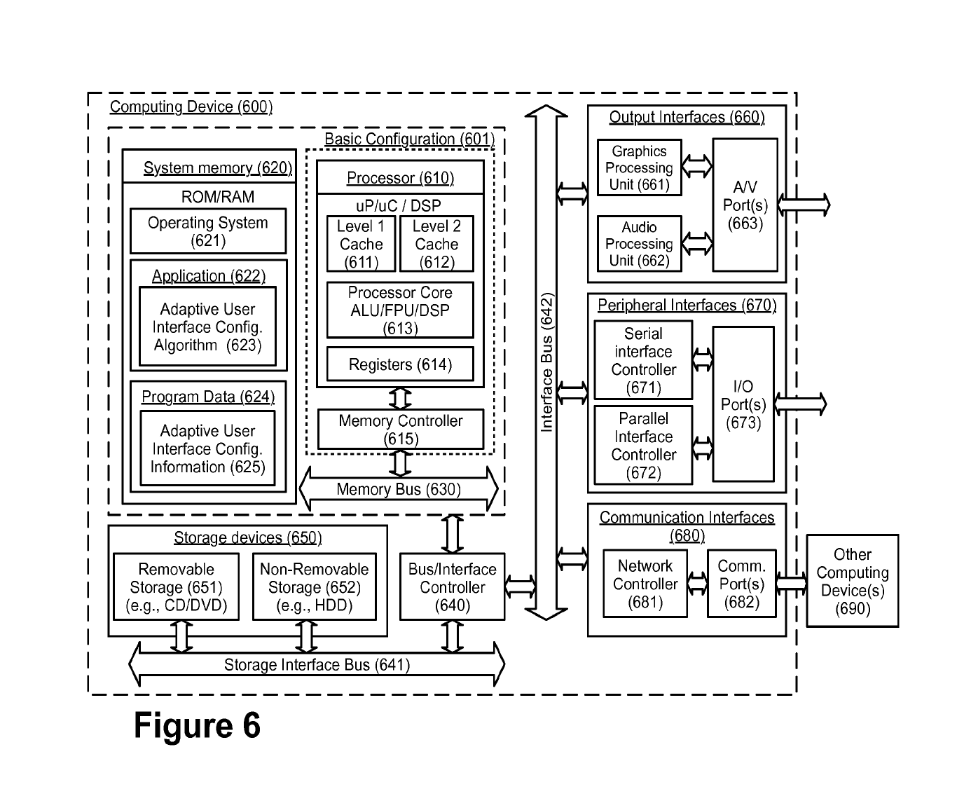

In general, the methods described with respect to FIG. 4 and elsewhere herein may be implemented in any suitable computing system. Example systems may be described with respect to FIG. 6 and elsewhere herein. In general, the system may be configured to facilitate configuring an adaptive user interface.

FIG. 6 is a block diagram illustrating an example computing device 600, such as might be embodied by a person skilled in the art, which is arranged in accordance with at least some embodiments of the present disclosure. In one example configuration 601, computing device 600 may include one or more processors 610 and system memory 620. A memory bus 630 may be used for communicating between the processor 610 and the system memory 620.

Depending on the desired configuration, processor 610 may be of any type including but not limited to a microprocessor (μP), a microcontroller (μC), a digital signal processor (DSP), or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 may also be used with the processor 610, or in some implementations the memory controller 615 may be an internal part of the processor 610.

Depending on the desired configuration, the system memory 620 may be of any type including but not limited to volatile memory (such as RAM), non-volatile memory (such as ROM, flash memory, etc.) or any combination thereof. System memory 620 may include an operating system 621, one or more applications 622, and program data 624. Application 622 may include adaptive user interface configuration algorithm 623 that is arranged to perform the functions as described herein including the functional blocks and/or actions described. Program Data 624 may include, among a wide variety of information described, adaptive user interface configuration information 625 for use with adaptive user interface configuration algorithm 623. In some example embodiments, application 622 may be arranged to operate with program data 624 on an operating system 621 such that implementations of configuring adaptive user interface may be provided as described herein. For example, apparatus described in the present disclosure may comprise all or a portion of computing device 600 and be capable of performing all or a portion of application 622 such that implementations of configuring adaptable user interface may be provided as described herein. This described basic configuration is illustrated in FIG. 6 by those components within dashed line 601.

Computing device 600 may have additional features or functionality, and additional interfaces to facilitate communications between the basic configurations 601 and any required devices and interfaces. For example, a bus/interface controller 640 may be used to facilitate communications between the basic configuration 601 and one or more data storage devices 650 via a storage interface bus 641. The data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 642 for facilitating communication from various interface devices (e.g., output interfaces, peripheral interfaces, and communication interfaces) to the basic configuration 601 via the bus/interface controller 640. Example output interfaces 660 may include a graphics processing unit 661 and an audio processing unit 662, which may be configured to communicate to various external devices such as a display or speakers via one or more NV ports 663. Example peripheral interfaces 660 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 690 over a network communication via one or more communication ports 682. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a tablet type device, a personal media player device, a wireless web-watch device, a personal headset device, an application specific device, or a hybrid device that includes any of the above functions. Computing device 600 may also be implemented as a personal computer including both laptop computer and non-laptop computer configurations. In addition, computing device 600 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussion utilizing terms such as “processing,” “computing,” “calculating,” “determining” or the like refer to actions or processes of a computing device that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as those employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon that, when executed by a computing device such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skilled in the art in light of this disclosure. In addition, those skilled in the art will appreciate that the mechanisms of the subject matter described herein are capable of being distributed as a product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for configuring an adaptive user interface associated with an electronic device, the method comprising:
receiving credential information from a user at the electronic device, via a first electronic communication medium;
receiving location information of the electronic device, via a second electronic communication medium;
determining environment information of the electronic device based, at least in part, on the received location information of the electronic device; and
configuring the adaptive user interface based, at least in part, on the credential information and/or the determined environment information.

2. The method of claim 1, wherein receiving the credential information from the user comprises receiving credential information from the user, via a wireless electronic communication medium.

3. The method of claim 2, wherein receiving the credential information from the user comprises receiving credential information from the user, via a radio-frequency identification (RFID) type wireless communication.

4. The method of claim 2, wherein receiving the credential information from the user comprises receiving credential information from the user, via at least one of a near field communication (NFC) type electronic communication medium and/or Bluetooth electronic communication medium.

5. The method of claim 2, wherein receiving the credential information from the user comprises receiving credential information from the user, via a wireless local area network (WLAN) electronic communication medium.

6. The method of claim 1, wherein receiving the credential information from the user comprises receiving credential information from the user, via a physical user interface type electronic communication medium.

7. The method of claim 6, wherein receiving the credential information from the user comprises receiving credential information from the user, via at least one of a graphical user type interface and/or a physical input type user interface.

8. The method of claim 1, wherein receiving location information of the electronic device comprises receiving location information of the electronic device, via a wireless local area network (WLAN) electronic communication medium.

9. The method of claim 1, wherein receiving location information of the electronic device comprises receiving location information of the electronic device, via substantially similar electronic communication medium as compared to the first electronic communication medium.

10. The method of claim 1, wherein receiving location information of the electronic device comprises receiving location information of the electronic device, via a local area network (LAN).

11. The method of claim 1 further comprising:
determining if a subsequent credential information is received at the electronic device;
determining if the subsequent credential information is different than the previously received credential information of from the user; and
locking the configured adaptive user interface from subsequent configuration upon determining the subsequent credential information is different than the previously received credential information of from the user.

12. The method of claim 1, wherein receiving location information of the electronic device comprises receiving location information of the electronic device, via a wireless electronic communication medium.

13. The method of claim 12, wherein receiving location information of the electronic device comprises receiving location information of the electronic device, via a global positioning system (GPS) related electronic communication medium.

14. A machine readable non-transitory medium having stored therein instructions that, when executed by one or more processors, operatively enable a user interface module to:
receive credential information from a user at an electronic device via a first electronic communication medium;
receive location information of the electronic device via a second electronic communication medium;
determine environment information of the electronic device based, at least in part, on the received location information of the electronic device; and
configure the adaptive user interface based, at least in part, on the credential information and/or the determined environment information.

15. A system for configuring an adaptive user interface associated with an electronic device comprising:
a processor;
a location module communicatively coupled to the processor;
a communication module communicatively coupled to the processor;
an adaptive user interface communicatively coupled to the processor; and
a user interface module communicatively coupled to the processor, the user interface module configured to:
receive credential information from a user at the electronic device via a first electronic communication medium;
receive location information of the electronic device via a second electronic communication medium;
determine environment information of the electronic device based, at least in part, on the received location information of the electronic device; and
configure the adaptive user interface based, at least in part, on the credential information and/or the determined environment information.

16. A method for configuring an adaptive user interface associated with a medical device, the method comprising:
receiving credential information from a user at the medical device, via a first electronic communication medium;
receiving location information of the medical device, via a second electronic communication medium;
determining environment information of the medical device based, at least in part, on the received location information of the medical device; and
configuring the adaptive user interface based, at least in part, on the credential information and/or the determined environment information.
